(19) United States
(12) Patent Application Publication
(10) Pub. No.: US 2026/0284678 A1
(43) Pub. Date: Sep. 24, 2026

(54) SEPARATOR FOR A FLUID CLEANING DEVICE

(71) Applicant: Dyson Technology Limited, Malmesbury, Wiltshire (GB)

(72) Inventors: Matthew Simon GOODLEY, Bristol (GB); Mateusz GUGALA, Gloucester (GB)

(21) Appl. No.: 18/874,192

(22) PCT Filed: Jun. 22, 2023
(86) PCT No.: PCT/IB2023/056457

§ 371 Date: Dec. 12, 2024

(30) Foreign Application Priority Data
Jun. 29, 2022 (GB) 2209549.1
Jun. 29, 2022 (GB) 2209565.7

(51) Int. Cl. B04C 9/00; A47L 9/16; A47L 9/20; B01D 45/16; B01D 46/58; B01D 46/681; B01D 50/20; B04C 5/185

(52) U.S. Cl. CPC B04C 9/00; A47L 9/1608; A47L 9/165; A47L 9/1666; A47L 9/1683; A47L 9/20; B01D 45/16; B01D 46/58; B01D 46/681; B01D 50/20; B04C 5/185; B01D 2279/55; B04C 2009/004

(57) ABSTRACT

A separator for a cleaning device is provided and includes an inlet for receiving a fluid flow containing entrained debris into the separator, an outlet for discharging a filtered fluid flow from the separator, an inlet duct connected to the inlet to receive the fluid flow, an outlet volume connected to the outlet, and a longitudinally-extending boundary wall. The outlet is spaced longitudinally from the inlet. The inlet duct extends within an interior volume of the separator. The longitudinally-extending boundary wall is interposed between the inlet duct and the outlet volume. The boundary wall includes a filter screen that is configured to retain the debris in the inlet duct while allowing filtered fluid to flow from the inlet duct to the outlet volume.

### TECHNICAL FIELD

The present invention relates to separators and separating processes for fluid cleaning devices.

### BACKGROUND

Many fluid cleaning devices implement an initial separation stage, such as a cyclonic separator, to remove the heaviest particles and/or debris from an incoming fluid flow and thereby act as the first in a series of purification stages implemented by the device. In the case of vacuum cleaning devices, a separator may replace a dust bag, in that the separator can be configured to remove and collect larger particulates and debris from an incoming flow of air. This creates a partially filtered flow, which may then be purified further by a fine dust separator and optionally additional filters such as a HEPA (high efficiency particulate air) filter, such that particulates of successively smaller sizes are removed from the flow to produce a purified output. When the separator is full it can be removed, emptied and returned to the device.

Various separator configurations are known, but typically a separator comprises a hollow housing assembly that encloses an internal volume that is divided into two mutually-isolated chambers by a separating grid, which is also referred to as a ‘shroud’ or ‘mesh’. The mesh acts as a filter screen that allows fluid and particles below a certain size to pass between the chambers, whilst blocking larger particles and debris. Incoming air containing debris is delivered into a first of these chambers, which is therefore an upstream chamber defining an inlet volume, which is connected to or encompasses a bin volume, or ‘primary bin’, in which debris collects. The second, downstream chamber on the opposite side of the mesh defines an outlet volume that is connected to an outlet, through which a filtered flow is discharged to be conveyed onwards within the device for further purification in additional separation stages.

The separator is configured to remove debris from the incoming airflow using a combination of inertial separation and mechanical separation, the latter of which is provided by the mesh. Inertial separation involves turning the airflow so that the entrained debris is carried out of the flow by its own momentum. The separator is configured so that this occurs in a region of the chamber that is spaced from the mesh, so that the accumulating debris does not cover the mesh until the primary bin is close to full. Meanwhile, the mesh prevents fibres and other lightweight debris that remain in the flow from passing through to the outlet volume.

In existing arrangements, during operation debris accumulates on a surface of the mesh and lodges in pores of the mesh, progressively blocking the mesh and so increasing resistance to air flow through the mesh. Blocking of the mesh in this manner may also be referred to as ‘mesh blinding’, which hinders performance of the device until the mesh is cleaned. The separator may therefore have to be cleaned prematurely before the primary bin is full, which increases the level of user maintenance required. Alternatively, a mechanical wiper may be provided to clear the mesh, but such wipers are often complex and prone to trapping debris against the mesh.

The rate at which the mesh blinds is related to the effectiveness with which debris is deposited at the intended accumulation point in the primary bin, in combination with the nature of the debris that is being drawn into the separator.

One approach to reducing mesh blinding is to increase the pore size of the mesh to reduce the likelihood of blockage. However, increasing the pore size inevitably allows larger particles to pass through the mesh, to the detriment of the separation efficiency of the separator, namely the proportion of debris that is captured in the primary bin.

Another measure that is taken is to limit the size of an inlet to the primary bin through which incoming air is discharged, in turn ensuring that the velocity of the air flow into the primary bin is high for a given flow rate. This high flow velocity inside the primary bin helps to reduce mesh blinding, but at the cost of increased jetting losses within the primary bin and in turn increased power consumption for the device. In this respect, in general terms it is desirable to minimise the pressure consumption of a separator.

WO 2011/161591 proposes a separator arrangement that is configured to reduce mesh blinding by directing a main inlet air flow at the mesh of a separator, so that the mesh is kept clean by the air flow in use. However, the mesh is vulnerable to damage from large and/or heavy objects that may be entrained in the incoming air flow.

It is against this background that the present invention has been devised.

### SUMMARY

In a first aspect, the present invention provides a separator for a cleaning device. The separator comprises: an inlet for receiving a fluid flow containing entrained debris into the separator; an outlet for discharging a filtered fluid flow from the separator, the outlet being spaced longitudinally from the inlet with respect to a longitudinal axis of the separator; an inlet duct extending within an interior volume of the separator, the inlet duct being connected to the inlet to receive the fluid flow; an outlet volume connected to the outlet; and a longitudinally-extending boundary wall interposed between the inlet duct and the outlet volume. The boundary wall comprises a filter screen that is configured to retain the debris in the inlet duct while allowing filtered fluid to flow from the inlet duct to the outlet volume. The inlet duct and the outlet volume may be enclosed and sealed from each other so that fluid communication occurs only through the filter screen.

Configuring a separator with a longitudinal boundary wall interposed between an inlet duct and an outlet volume, and an inlet and an outlet that are spaced longitudinally, enables features of the separator to be arranged with a substantially in-line topology. In other words, the inlet, the outlet, the inlet duct and the outlet volume can be arranged close to alignment with each other. This, in turn, allows a main flow path for fluid through the separator to be close to linear, thereby reducing the extent to which the flow must turn between the inlet and the outlet and in turn lowering the pressure consumption of the separator. The separator may also be configured for reduced recirculation of fluid, thereby avoiding some of the drawbacks associated with cyclonic configurations.

The filter screen may extend parallel to a longitudinal axis of the separator.

The inlet duct may extend longitudinally from the inlet. The inlet duct optionally extends along a central longitudinal axis of the separator, such that the central longitudinal axis extends within an envelope of the inlet duct.

The inlet duct may comprise a side opening. For example, the inlet duct may comprise an open-sided channel. The side opening may be on an opposite side of the inlet duct to the filter screen.

The separator may comprise a bin volume connected to the inlet duct, the bin volume being configured to collect debris retained by the filter screen. The side opening of the inlet duct may open into the bin volume. Optionally, the bin volume at least partially surrounds the inlet duct and/or the outlet volume.

The outlet volume may comprise at least one outlet duct.

The outlet volume may at least partially surround the inlet duct, and optionally fully surrounds the inlet duct so that the inlet duct is nested within the outlet volume.

In some embodiments, the filter screen at least partially extends around the inlet duct in a plane transverse to the longitudinal axis of the separator.

The filter screen may taper longitudinally.

The inlet and the outlet may be disposed at opposed longitudinal ends of the separator.

The inlet duct may be terminated by an end wall of the separator.

A distal end of the inlet duct may be closed.

The separator may comprise a wiping member configured to move across the filter screen to remove debris attached to the filter screen. The wiping member may be configured to move parallel to a longitudinal axis of the separator.

The boundary wall may be defined by a wall of the inlet duct. Alternatively, or in addition, the boundary wall may be defined by a wall of the outlet volume, and optionally a wall enclosing the outlet volume. The wall of the outlet volume may comprise a recessed portion defining the inlet duct.

A transverse profile of the inlet duct and/or the outlet volume may be uniform longitudinally.

The separator may comprise a second filter screen extending parallel to the filter screen. The second filter screen may be configured to retain debris in the bin volume, if present, while allowing filtered fluid to flow from the bin volume to the outlet volume. The separator may comprise a primary flow path extending between the inlet and the outlet through the filter screen, and a secondary flow path extending between the inlet and the outlet through the second filter screen, in which case the separator comprises at least one barrier formation located on the secondary flow path to constrain fluid flow along the secondary flow path relative to fluid flow along the primary flow path. The barrier formation therefore provides a means for controlling how the incoming flow divides between the primary and secondary flow paths.

The secondary flow path provides an alternative route for fluid to exit the separator, thereby enhancing control over fluid flow within the separator and optionally reducing recirculation of fluid within the separator. Positioning the second filter screen between the bin volume and the outlet volume influences fluid flow through the bin volume, promoting effective depositing of debris.

The, or each, filter screen may curve around a longitudinal axis of the separator.

A second aspect of the invention provides a cleaning device comprising the separator of the first aspect. The device may be embodied as a domestic appliance, for example.

Configuring a device with a separator with a longitudinal boundary wall interposed between an inlet duct and an outlet volume, and an inlet and an outlet that are spaced longitudinally, enables features of the separator to be arranged with a substantially in-line topology. In other words, the inlet, the outlet, the inlet duct and the outlet volume can be arranged close to alignment with each other. This, in turn, allows a main flow path for fluid through the separator to be close to linear, thereby reducing the extent to which the flow must turn between the inlet and the outlet and in turn lowering the pressure consumption of the separator and therefore the power consumption of the device. The separator may also be configured for reduced recirculation of fluid, thereby avoiding some of the drawbacks associated with cyclonic configurations.

A third aspect of the invention provides a method of configuring a separator for a cleaning device. The separator comprises an inlet for receiving a fluid flow containing entrained debris into the separator, an outlet for discharging a filtered fluid flow from the separator, the outlet being spaced longitudinally from the inlet, and an outlet volume connected to the outlet. The method comprises: connecting an inlet duct extending within an interior volume of the separator to the inlet to receive the fluid flow; and interposing a longitudinally-extending boundary wall between the inlet duct and the outlet volume. The boundary wall comprises a filter screen that is configured to retain the debris in the inlet duct while allowing filtered fluid to flow from the inlet duct to the outlet volume.

Configuring a separator with a longitudinal boundary wall interposed between an inlet duct and an outlet volume, and an inlet and an outlet that are spaced longitudinally, enables features of the separator to be arranged with a substantially in-line topology. In other words, the inlet, the outlet, the inlet duct and the outlet volume can be arranged close to alignment with each other. This, in turn, allows a main flow path for fluid through the separator to be close to linear, thereby reducing the extent to which the flow must turn between the inlet and the outlet and in turn lowering the pressure consumption of the separator. The separator may also be configured for reduced recirculation of fluid, thereby avoiding some of the drawbacks associated with cyclonic configurations.

In a fourth aspect, there is described herein a separator for a cleaning device. The separator comprises: an inlet volume connected to an inlet of the separator for receiving a fluid flow containing entrained debris into the separator; a bin volume connected to the inlet volume, the bin volume being configured to collect debris separated from the fluid flow; an outlet volume connected to an outlet of the separator for discharging a filtered fluid flow from the separator; a first filter screen extending between the inlet volume and the outlet volume, the first filter screen being configured to retain debris in the inlet volume while allowing filtered fluid to flow from the inlet volume to the outlet volume; and a second filter screen extending between the bin volume and the outlet volume. The second filter screen is configured to retain debris in the bin volume while allowing filtered fluid to flow from the bin volume to the outlet volume. The inlet volume and the outlet volume may be enclosed and sealed from each other so that fluid communication occurs only through the filter screens.

Configuring a separator with first and second filter screens guarding respective entrances to the outlet volume provides multiple routes between the inlet and the outlet. This, in turn, enhances control over fluid flow within the separator and increases the extent to which recirculation of fluid within the separator can be reduced, thereby avoiding some of the drawbacks associated with cyclonic configurations. Positioning the second filter screen between the bin volume and the outlet volume influences fluid flow through the bin volume, promoting effective depositing of debris.

The first filter screen and the second filter screen may be mutually parallel.

The first filter screen and/or the second filter screen may extend parallel to a longitudinal axis of the separator.

The separator may comprise a wiping member configured to move across the first filter screen to remove debris attached to the first filter screen. The wiping member may be configured to move across the first and second filter screens simultaneously to remove debris attached to the first and second filter screens. For example, the wiping member may comprise a continuous wiping edge, the wiping edge having a portion that engages the first filter screen and another portion that engages the second filter screen, in use. The wiping member is optionally configured to move parallel to a longitudinal axis of the separator. The wiping member may be supported by an end wall of the separator.

The first and second filter screens may be fixed relative to a housing of the separator, and the wiping member may be configured to move relative to the housing. Alternatively, the wiping member may be fixed relative to a housing of the separator, and the first and second filter screens may be configured to move relative to the housing. In a further alternative, the wiping member and the first and second filter screens may be configured to move relative to the housing or another structure of the separator.

In some embodiments, the wiping member comprises a wiping edge that forms a closed loop, which wiping edge engages both the first filter screen and the second filter screen in operation.

The wiping member may be configured for actuation externally of the separator.

The inlet volume may comprise at least one inlet duct connected to the inlet to receive the fluid flow, in which case the first filter screen extends between the inlet duct and the outlet volume to retain debris in the inlet duct while allowing filtered fluid to flow from the inlet duct to the outlet volume. The inlet duct may extend parallel to the first filter screen. The first filter screen may form part of a longitudinally-extending boundary wall interposed between the inlet duct and the outlet volume. A wall of the inlet duct may comprise the boundary wall. The inlet duct may extend along a central longitudinal axis of the separator, such that the central longitudinal axis extends within an envelope of the inlet duct.

The inlet duct may comprise a side opening. For example, the inlet duct may comprise an open-sided channel. The side opening may be on an opposite side of the inlet duct to the filter screen.

The outlet volume may comprise at least one outlet duct.

The separator may comprise a primary flow path extending between the inlet and the outlet through the first filter screen, and a secondary flow path extending between the inlet and the outlet through the second filter screen. The separator may comprise at least one barrier formation located on the secondary flow path to constrain fluid flow along the secondary flow path relative to fluid flow along the primary flow path. The barrier formation therefore provides a means for controlling how the incoming flow divides between the primary and secondary flow paths.

The first filter screen and/or the second filter screen may curve around a longitudinal axis of the separator.

The second filter screen may form part of a longitudinally-extending boundary wall interposed between the bin volume and the outlet volume. The outlet may be spaced longitudinally from the inlet with respect to a longitudinal axis of the separator. Configuring a separator with a longitudinal boundary wall interposed between an inlet duct and an outlet volume, and an inlet and an outlet that are spaced longitudinally, enables features of the separator to be arranged with a substantially in-line topology. In other words, the inlet, the outlet, the inlet duct and the outlet volume can be arranged close to alignment with each other. This, in turn, allows a main flow path for fluid through the separator to be close to linear, thereby reducing the extent to which the flow must turn between the inlet and the outlet and in turn lowering the pressure consumption of the separator. The separator may also be configured for reduced recirculation of fluid, thereby avoiding some of the drawbacks associated with cyclonic configurations.

A fifth aspect there is described herein a cleaning device comprising the separator of the fourth aspect. The device may be embodied as a domestic appliance, for example.

Configuring a device with a separator with first and second filter screens guarding respective entrances to the outlet volume provides multiple routes between the inlet and the outlet. This, in turn, enhances control over fluid flow within the separator and increases the extent to which recirculation of fluid within the separator can be reduced, thereby avoiding some of the drawbacks associated with cyclonic configurations. Positioning the second filter screen between the bin volume and the outlet volume influences fluid flow through the bin volume, promoting effective depositing of debris.

A sixth aspect described herein provides a method of configuring a separator for a cleaning device. The separator comprises an inlet volume connected to an inlet of the separator for receiving a fluid flow containing entrained debris into the separator, a bin volume connected to the inlet volume, the bin volume being configured to collect debris separated from the fluid flow, and an outlet volume connected to an outlet of the separator for discharging a filtered fluid flow from the separator. The method comprises: positioning a first filter screen between the inlet volume and the outlet volume, the first filter screen being configured to retain debris in the inlet volume while allowing filtered fluid to flow from the inlet volume to the outlet volume; and positioning a second filter screen between the bin volume and the outlet volume, the second filter screen being configured to retain debris in the bin volume while allowing filtered fluid to flow from the bin volume to the outlet volume.

Configuring a separator with first and second filter screens guarding respective entrances to the outlet volume provides multiple routes between the inlet and the outlet. This, in turn, enhances control over fluid flow within the separator and increases the extent to which recirculation of fluid within the separator can be reduced, thereby avoiding some of the drawbacks associated with cyclonic configurations. Positioning the second filter screen between the bin volume and the outlet volume influences fluid flow through the bin volume, promoting effective depositing of debris.

Features described above in connection with the first aspect of the invention are equally applicable to the second, third, fourth, fifth and/or sixth aspect(s), and vice versa.

### BRIEF DESCRIPTION OF THE DRAWINGS

FIG. 1 shows a rear view of a separator for a fluid cleaning device;

FIG. 2 corresponds to FIG. 1, but shows the separator with a wiper element hidden;

FIG. 3 shows the separator of FIG. 1 in longitudinal cross-section from above;

FIG. 4 shows the separator of FIG. 1 in longitudinal cross-section from the side;

FIG. 5 corresponds to FIG. 4 but shows air movement within the separator;

FIG. 6 shows the separator of FIG. 1 in front perspective view;

FIG. 7 corresponds to FIG. 6 but shows a partial cutaway view;

FIG. 8 corresponds to FIG. 6 but shows the separator in longitudinal cross-section;

FIG. 9 shows the separator of FIG. 1 in rear perspective view;

FIG. 10 corresponds to FIG. 9 but shows a partial cutaway view;

FIG. 11 corresponds to FIG. 9 but shows the separator in longitudinal cross-section;

FIGS. 12a to 12c show internal components of the separator of FIG. 1 in perspective view with a wiper assembly at three stages of a wiping movement;

FIGS. 13a and 13b correspond to FIGS. 12b and 12c respectively, but show the separator in longitudinal cross-section from the side;

FIGS. 14a and 14b correspond to FIGS. 13a and 13b respectively, but show a separator configured for an alternative wiping movement;

FIGS. 15a and 15b correspond to FIGS. 14a and 14b respectively, but show the separator in rear perspective view; and

FIGS. 16a and 16b correspond to FIGS. 14a and 14b respectively, but show the separator in front perspective view.

### DETAILED DESCRIPTION

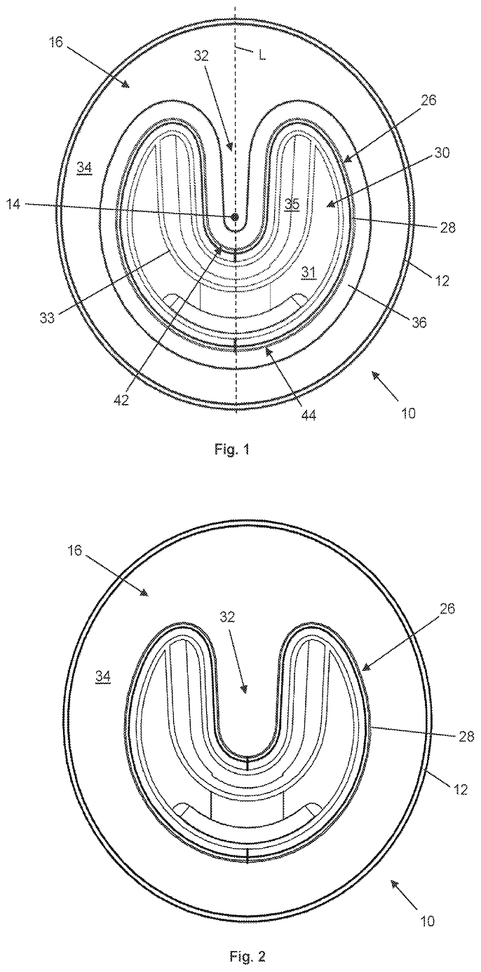

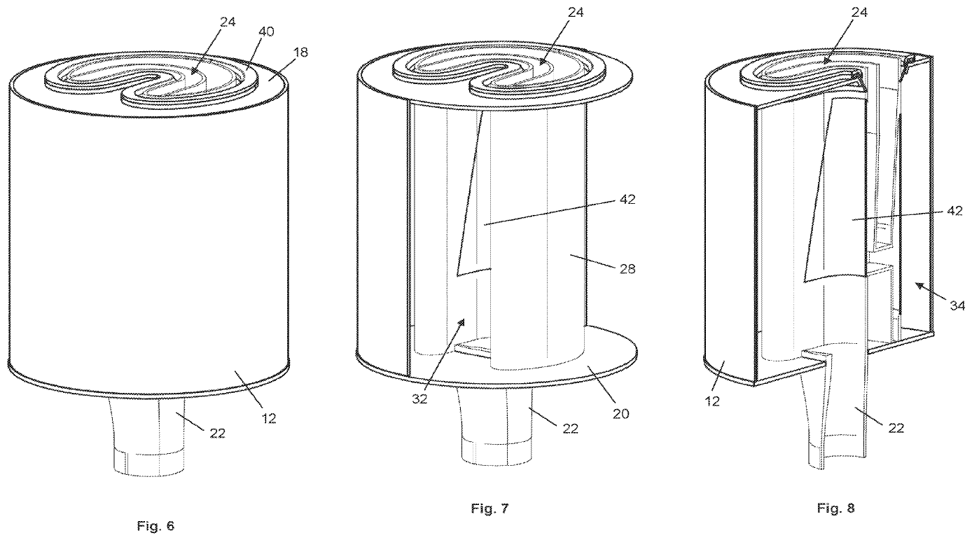

FIGS. 1 to 11 show an example of a separator 10 for use in a fluid cleaning device, and are described collectively below. In general terms, the separator 10 is configured for reduced mesh blinding and low pressure consumption relative to known arrangements. In this example, the separator 10 is configured for use in a domestic vacuum cleaning appliance, but it will be appreciated that other examples of such separators are applicable to a range of cleaning devices.

In a departure from convention, the separator 10 of this example is not configured as a cyclonic separator, but instead is configured to guide airflow for reduced recirculation by creating multiple fluid outlet routes, each being guarded by a respective mesh. This allows the separator to avoid some of the drawbacks associated with cyclonic configurations, including a propensity for the circulating flow to wrap elongate debris such as hairs and fibres around internal components, and the constraints placed on the shape of the primary bin due to the need for it to create the required cyclonic flow. It is noted, however, that in other examples separators may be configured with a single mesh guarding a single outlet, in which case the separator is configured for limited recirculation.

In general terms, the separator 10 of this example is configured with an in-line topology, in which the inlet, the outlet and the meshes all extend substantially parallel to a common axis, in this case the central axis of the separator 10. This allows for a compact and elegant layout, and also simplifies the flow path by reducing the extent to which the flow must turn between the inlet and the outlet, thereby lowering pressure consumption. The in-line topology may however be optional.

In addition, having a primary mesh parallel to the direction of incoming air flow through the inlet helps to reduce mesh blinding, as the air flow continuously washes the mesh aerodynamically in operation.

Meanwhile, a mechanical wiper is provided that, by virtue of the in-line topology, is capable of cleaning both meshes simultaneously in a single linear movement, thereby reducing complexity and easing maintenance. Mechanical wipers may be favoured for their ease of implementation and perceived reliability, although in other examples aerodynamic wiping arrangements may be employed where space allows.

As FIG. 1 shows, the separator 10 comprises a casing 12 defined by a tubular wall of circular cross-section, which wall encircles a central axis 14 to enclose a cylindrical interior volume 16. The central axis 14 also defines a central longitudinal axis of the separator 10.

It is noted that casings of various alternative shapes may be used in other examples, including cuboidal casings for example. The separator 10 offers greater flexibility in this respect, compared to cyclonic separators that rely on the housing shape to achieve the required circulatory flow.

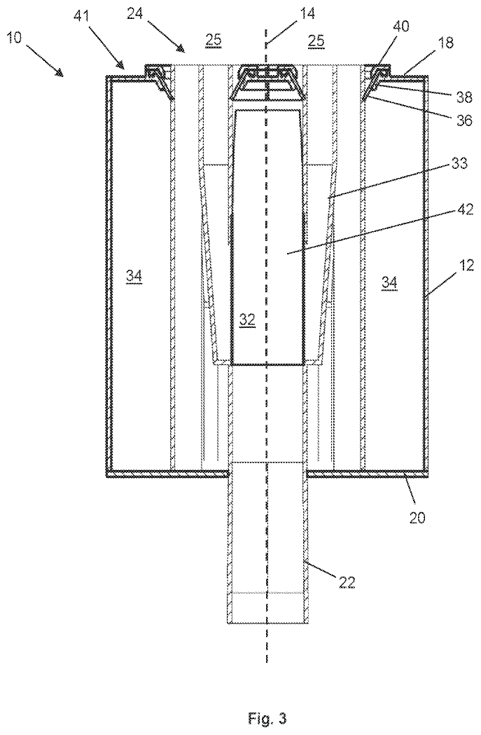

The separator 10 is configured for use with its central axis 14 typically oriented at approximately 45°, such that opposed longitudinal ends of the casing 12 respectively define an upper end and a lower end of the casing 12. FIG. 3 shows that the upper end of the casing 12 is closed by an upper end wall 18, and correspondingly the lower end of the casing 12 is closed by a lower end wall 20, the upper and lower end walls 18, 20 being represented as planar, mutually-parallel discs.

The upper and lower end walls 18, 20 and the casing 12 collectively define a housing of the separator 10 that encloses the interior volume 16.

Although not shown in the figures for simplicity, the lower end wall 20 is removable from the casing 12 to allow emptying of the interior volume 16, and may be connected to the casing 12 via a hinge for example.

Meanwhile, in this example the upper end wall 18 is configured to move relative to the casing 12, within the interior volume 16, to act as a mechanical wiper for cleaning meshes of the separator 10, as described below.

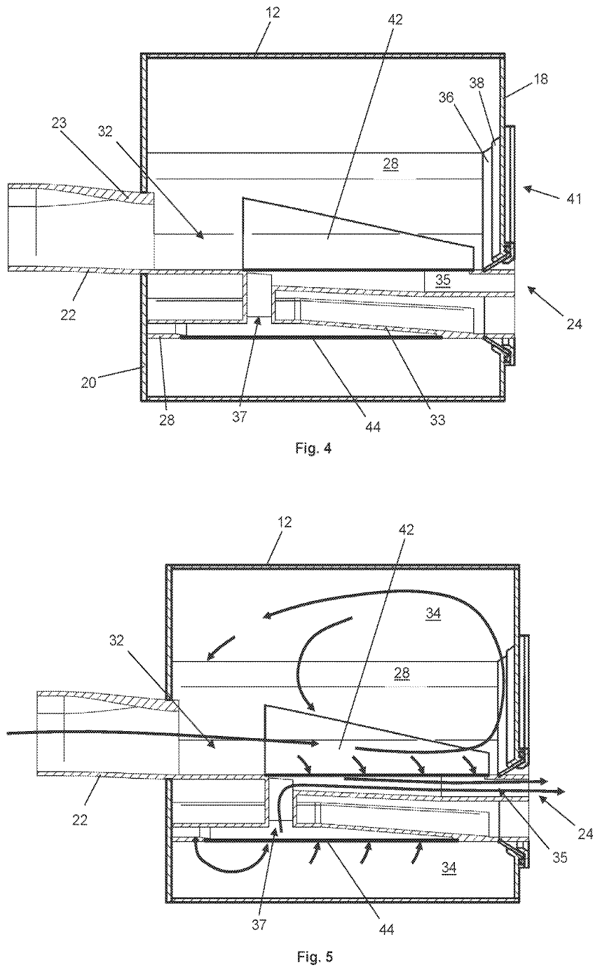

A tube defining an inlet 22 is also visible in FIG. 3, the inlet 22 extending through a central opening in the lower end wall 20 to project into the interior volume 16 of the separator 10. The inlet 22 is generally tubular and has an axis that is parallel to the central axis 14 of the separator 10. In use, the external portion of the inlet 22 outside the separator 10 is connected to ducting within the device, through which a flow of air to be filtered is pumped into the separator 10. FIG. 4 shows that an upper side of the inlet 22 is recessed radially inwardly to create a lip 23 that acts as a flow guide, as shall become clear in the description that follows.

Correspondingly, the upper end wall 18 includes an outlet opening that accommodates an outlet 24 of the housing of the separator 10. The outlet 24 defines an outlet axis that is parallel to, and in close proximity with, the central axis 14 of the separator 10. When the separator 10 is in use in the device, the outlet 24 discharges a filtered flow from the separator 10 that is conveyed by suitable connections to additional purification stages within the device. For example, the outlet 24 may deliver the flow to a cyclone pack that acts as a second separation stage.

Accordingly, the inlet 22 and the outlet 24 of the separator 10 are disposed at opposed longitudinal ends of the casing 12. The inlet 22 and the outlet 24 are offset from each other radially only to a small degree, so that the extent to which air flow must turn between the inlet 22 and the outlet 24 is correspondingly small. Positioning the outlet 24 close to the central axis 14 advantageously also typically places it in closer alignment with downstream features of the device such as cones. Accordingly, the separator 10 is configured to minimise the overall changes in flow direction for air conveyed through the device, in turn reducing pressure consumption.

Returning to FIG. 1, a duct arrangement 26 is accommodated within the interior volume 16 of the casing 12, the duct arrangement 26 being generally U-shaped in transverse cross-section as shown in FIG. 1. More specifically, the duct arrangement 26 comprises a duct wall 28 that extends in a closed loop in the transverse plane shown in FIG. 1, to enclose a volume that is surrounded by, and substantially fluidly isolated from, the remainder of the interior volume 16. The volume enclosed by the duct wall 28 is connected to the outlet 24 and so defines an outlet volume or outlet chamber 30. Correspondingly, the portion of the interior volume 16 outside the duct wall 28 defines an inlet volume.

The duct wall 28 is symmetrical about a longitudinal plane represented by a radial line L in FIG. 1. A majority of the transverse profile of the duct wall 28 is generally circular and centred on the central axis 14, and so follows the profile of the casing 12 with a substantially constant radial offset. However, an upper region of the wall 28, as viewed in FIG. 1, is recessed radially inwardly to form an open-sided channel 32 that extends longitudinally along the exterior of the duct wall 28. In this respect, the duct wall 28 departs from its circular profile at mirrored positions either side of the radial line L, to curve sharply inwardly towards the central axis 14. Following the initial sharp curves, the duct wall 28 has a pair of mutually-parallel, substantially straight sections either side of the radial line L that are connected by a semi-circular portion centred on, and extending beneath, the central axis 14. The channel 32 therefore has planar sides connected by a part-tubular base. The cross-section of the channel 32 is substantially uniform longitudinally, and the channel 32 contains and extends along the central longitudinal axis 14.

The open-sided channel 32 defines an inlet duct 32 that is connected to the inlet 22 and therefore receives an incoming flow of air containing entrained debris. In this respect, FIG. 3 shows that the respective ends of the inlet duct 32 and the inlet 22 are of matching profiles and abut each other, so that the inlet 22 is substantially continuous with the inlet duct 32.

The remaining part of the inlet volume, outside of the inlet duct 32, defines a bin volume 34 that acts as a dust receptacle in which debris removed from the incoming air is collected. The inlet volume is therefore composed of the inlet duct 32 and the bin volume 34 in this example. The duct wall 28 therefore separates the bin volume 34 from the outlet chamber 30.

FIG. 4 reveals that the portion of the duct wall 28 defining the inlet duct 32 that engages the inlet 22 is recessed longitudinally inward relative to the remainder of the duct wall 28, which engages the inner surface of the lower end wall 20. The duct wall 28 and the inlet 22 therefore cooperate to close and seal the end of the outlet chamber 30 around the inlet 22 from the inlet volume, using suitable seals at the interfaces.

FIG. 1 also shows a U-shaped wall within the outlet chamber 30 that is at a substantially constant offset from the portion of the duct wall 28 defining the inlet duct 32. A curved wall extends between the tips of the U-shaped wall, to form a continuous crescent-shaped wall defining a barrier 33. FIG. 3 shows that the walls of the barrier 33 are of uniform width for an upper portion of the barrier 33, and then taper to converge longitudinally in a lower portion of the barrier 33.

The barrier 33 encloses a portion of the space within the outlet chamber 30, which defines a cavity 31 that may be unused, or used as a fine dust collector, for example. Meanwhile, a remaining portion of the outlet chamber, between the barrier 33 and the duct wall 28, defines a longitudinally-extending outlet duct 35 that is open at its upper end. Due to the convergence of the walls of the barrier 33 in its lower portion, the outlet duct 35 widens longitudinally upwards, in the orientation shown in FIG. 3.

As best seen in FIG. 4, the barrier 33 terminates approximately two-thirds of the way towards the lower end wall 20, the space inside the barrier 33 being closed by a planar, transversely-extending wall. This wall is spaced from a further, parallel wall of the duct arrangement 26, within the outlet chamber 30, to define a radial passage 37 between the walls that provides fluid communication between the outlet duct 35 and regions of the outlet chamber 30 radially outward of the barrier 33.

FIG. 3 shows that the duct wall 28 extends longitudinally through the outlet opening in the upper end wall 18, so that a terminal upper end of the duct wall 28 protrudes beyond the exterior of the upper end wall 18. It follows that the upper end of the outlet duct 35 protrudes from the housing and so defines the outlet 24 of the separator 10.

The outlet opening in the upper end wall 18 is shaped to match the profile of the duct wall 28, but sized to create a small clearance around the exterior of the duct wall 28. A resilient wiping member, or wiper element 36, extends across this clearance at an inclined angle to engage the outer surface of the duct wall 28. The wiper element 36 may, for example, be fabricated from a durable, compliant material such as a silicone. The wiper element 36 is supported by an inwardly inclined lip 38 formed around the outlet opening in the upper end wall 18, and is fixed to the upper end wall 18 by a clamp element 40 attached to the exterior of the upper end wall 18, to hold an outer edge of the wiper element 36 captive.

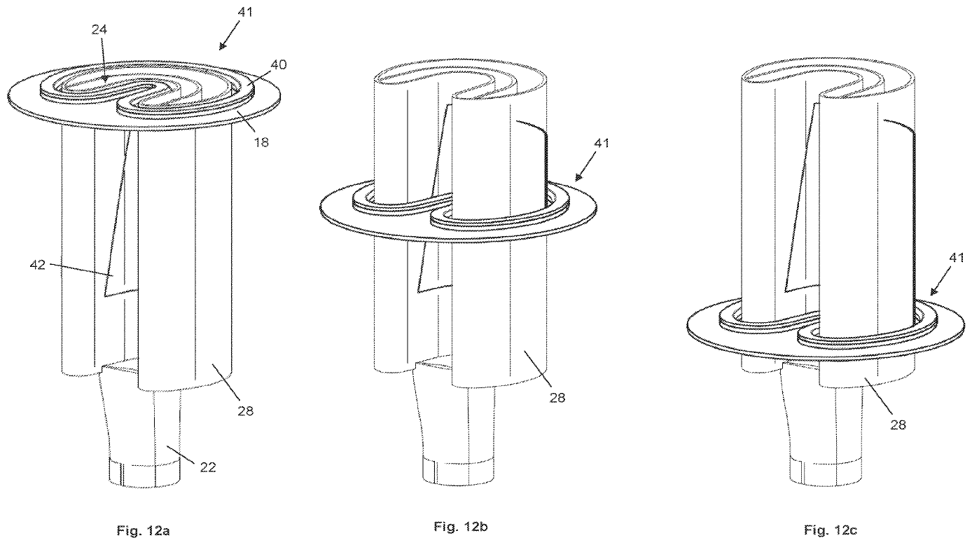

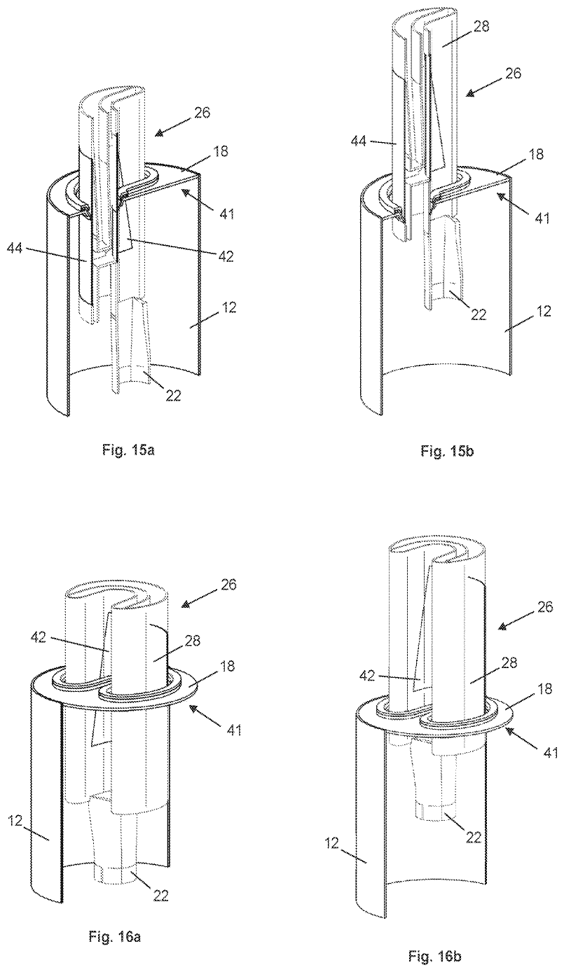

The upper end wall 18, the wiper element 36 and the clamp element 40 collectively form a wiper assembly 41, the operation of which is described later with reference to FIGS. 12 to 16.

The wiper element 36 is visible in FIG. 1, which shows how the element 36 is shaped to conform to the profile of the duct wall 28. FIG. 2, meanwhile, shows the separator 10 with the wiper element 36 hidden, for clarity.

The wiper element 36 forms a seal around the exterior surface of the duct wall 28. Meanwhile, the peripheral edge of the upper end wall 18 forms a seal against the casing. Accordingly, the inlet volume is sealed at one end by the wiper assembly 41, and at the other end by the upper end wall 18. The wiper element 36 is also arranged to clear debris mechanically from meshes of the duct arrangement 26, as described in more detail later.

In this respect, the duct arrangement 26 includes a pair of meshes that act as filter screens to control air flow into the outlet chamber 30 from the inlet duct 32 and the bin volume 34, to prevent debris of a certain size from entering the outlet chamber 30.

Specifically, as best seen in FIG. 3, a primary mesh 42 is disposed within the inlet duct 32 and largely defines the curved portion of the inlet duct 32. The primary mesh 42 is therefore diametrically opposed to the side opening of the inlet duct 32 with respect to the central axis 14. Meanwhile, FIGS. 4 and 10 show a secondary mesh 44 positioned on a rear of the duct wall 28, in angular alignment with the primary mesh 42 so that respective circumferential midpoints of the primary and secondary meshes 42, 44 may be intersected by a common radial line.

The primary mesh 42 serves to filter air flowing directly from the inlet duct 32 into the outlet chamber 30. As FIG. 4 shows best, the primary mesh 42 extends from a position longitudinally inboard of the inlet 22, for example being spaced from the inlet 22 by approximately a quarter of the length of the inlet duct 32, to a point a short distance from the distal end of the inlet duct 32. The primary mesh 42 therefore extends along approximately two thirds of the length of the inlet duct 32. The primary mesh 42 and the outlet duct 35 are of approximately the same length, such that the outlet duct 35 extends beside the primary mesh 42 along its length, on the opposite side to the inlet duct 32.

The secondary mesh 44 extends along a similar proportion of the inlet duct 32 to the primary mesh 42, but is offset towards the inlet 22 relative to the primary mesh 42. More specifically, the secondary mesh 44 extends from a junction between the barrier 33 and the duct wall 28, to a point spaced slightly inboard of the lower end wall 20. FIG. 10 shows that the secondary mesh 44 extends circumferentially around the duct wall 28 by approximately a quarter of the circumference, and has a uniform circumferential width. The secondary mesh 44 is therefore part-tubular in shape.

Each of the primary and secondary meshes 42, 44 extends parallel to the central axis 14 in this example, and therefore also parallel to each other.

It follows from the above that, in this example, the secondary mesh 44 and the curved portion of the primary mesh 42 each have an approximately constant radius of curvature centred on the central axis 14. In addition, each of the primary and secondary meshes 42, 44 is symmetrical about the common plane indicated by the radial line L in FIG. 1. It is noted that the shapes and relative positions of the meshes 42, 44 may be different in other examples, however.

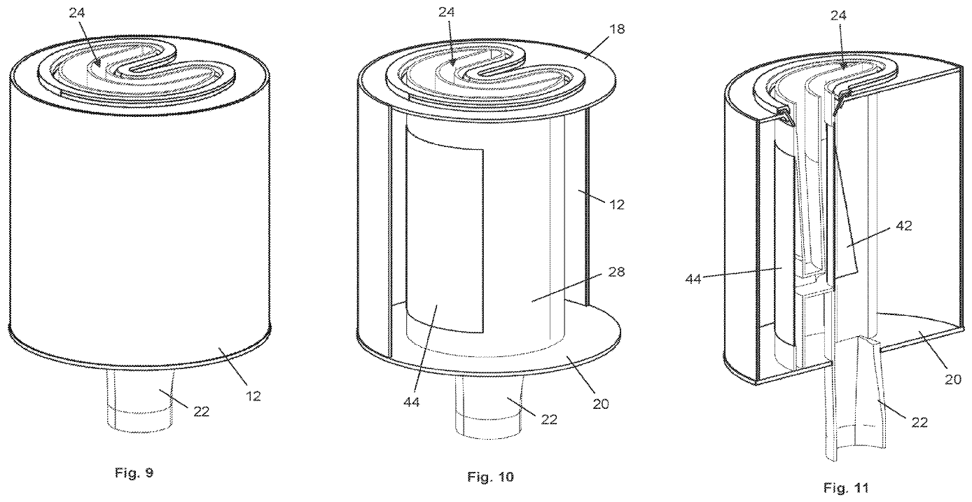

FIGS. 4 and 8 also reveal that the primary mesh 42 tapers longitudinally, the tapering being linear in this example. At its widest, at the end closest to the inlet 22, the primary mesh 42 extends around the entire curved portion of the inlet duct 32 and also encroaches some way onto the planar side portions of the inlet duct 32. Conversely, at its longitudinally opposite end the primary mesh 42 is at its narrowest and does not reach the planar side portions of the inlet duct 32. As shall become clearer from the description that follows, the tapering of the primary mesh 42 compensates for slowing of air flowing through the inlet duct 32, parallel to the mesh 42, and so aids with keeping the mesh 42 clear of debris. The tapering of the mesh 42 also reduces blinding of the mesh 42 through aero-optimisation of the flow across the mesh 42.

Each of the primary and secondary meshes 42, 44 covers, or is embedded in, a respective aperture in the duct wall 28. Each mesh 42, 44 is shaped to conform to the exterior surface of the duct wall 28 in which it is mounted, to maintain the smooth exterior profile of the duct wall 28 to minimise the impact of the meshes 42, 44 on aerodynamics in the inlet volume. Accordingly, each mesh 42, 44 may be considered to define a corresponding portion of the duct wall 28.

The primary and secondary meshes 42, 44 therefore form part of the duct wall 28, which in turn defines a boundary wall extending longitudinally between the inlet volume and the outlet chamber 30, to separate the inlet volume from the outlet chamber 30. The boundary wall is therefore defined by a portion of the duct wall 28 that is interposed between the inlet volume and the outlet chamber 30. Accordingly, air entering the inlet volume through the inlet 22 must pass through one of the meshes 42, 44 to reach the outlet chamber 30, the outlet duct 35 and the outlet 24. The meshes 42, 44 prevent particles of a certain size from passing into the outlet chamber 30, so that such particles accumulate in the bin volume 34.

In this respect, each mesh 42, 44 is a porous screen configured to act as a filter screen, and may have a pore size in the range of 100-500 microns, for example. The pores may have various shapes, including circular, oval or polygonal pores, for example. Rectangular pores, where used, may be oriented perpendicular to the incoming flow direction, particularly for the primary mesh 42. The profiles of the leading edges of the pores, relative to the direction of the incoming air flow, may influence the separating performance of the primary mesh 42.

The curved profiles of the meshes 42, 44 generally enhance separating performance relative to equivalent planar meshes.

Each mesh 42, 44 may be formed of plastic, or from metal with the pores being chemically-etched or electro-formed. Each mesh 42, 44 may mount to the respective opening in the duct wall 28 in any suitable way. It is also possible for one or both meshes 42, 44 to be formed integrally with the duct wall 28.

Having described the structure of the separator 10, air flow within the separator 10 in operation shall now be considered, before moving on to describe operation of the wiper assembly 41.

In operation, suction is induced by a vacuum motor of the device. The motor is disposed downstream of the outlet 24 of the separator 10, and therefore applies suction to the outlet 24 to create air flow through the separator 10 due to a pressure differential between the inlet 22 and the outlet 24.

FIG. 5 represents the resulting air flow within the separator 10, which shows that an inlet air flow is drawn into the inlet duct 32 from the inlet 22. As the inlet 22, the inlet duct 32 and the primary mesh 42 are all parallel to the central axis 14, the inlet air flow is generally parallel to, and therefore flows across, the primary mesh 42. FIG. 5 also shows that the lip 23 of the inlet 22 acts to guide the inlet air flow slightly downwardly, in the orientation shown in FIG. 5, and therefore into the inlet duct 32 and towards the primary mesh 42.

As the outlet chamber 30 is at lower pressure than the inlet duct 32, a portion of the inlet flow is diverted from its initial trajectory and drawn directly through the primary mesh 42 into the outlet duct 35, to be discharged through the outlet 24. This portion of the inlet flow that is drawn through the primary mesh 42 defines a primary flow.

The remaining portion of the flow that does not pass through the primary mesh 42 defines a secondary flow, which continues towards the distal end of the inlet duct 32 and then turns to flow out of the inlet duct 32 through its open side, and into the bin volume 34. Although not visible in the figures, a ramp, lip or other aerodynamic formation may be provided at the distal end of the inlet duct 32, to guide the secondary flow through the initial turn as it reaches the upper end wall 18.

The secondary flow carries the entrained debris that was present in the original inlet flow, which debris is prevented from crossing into the outlet chamber 30 with the primary flow by the primary mesh 42. Also, the momentum of the debris acts to hold the debris on a straight course, parallel to the primary mesh 42, in that the debris cannot turn as quickly as the air joining the primary flow. This helps to encourage debris into the secondary flow and therefore prevents debris from passing through or attaching to the primary mesh 42.

After turning at the end of the inlet duct 32, the secondary flow is drawn circumferentially around the bin volume 34 towards the secondary mesh 44, which is also connected to the lower pressure outlet volume 30. The geometry of the bin volume 34 and the size, shape and position of the secondary mesh 44 act to pull the secondary flow in various directions, causing the flow to spread and disperse and while changing direction. This, in turn, removes larger and/or heavier debris from the flow by inertial separation, these particles being carried out of the flow by their relatively high momentum, to be deposited in the bin volume 34. Smaller and/or lighter debris such as fluff and fibres also accumulate in the bin volume 34. In turn, accumulated fluff and fibres can help to catch dust conveyed subsequently into the bin volume 34 by the secondary flow. Any particles above a threshold size remaining in the secondary flow as it reaches the secondary mesh 44 are captured by the secondary mesh 44.

So, only air and particles that are smaller than the pores of the primary and secondary meshes 42, 44 can pass through either of the meshes 42, 44 to flow into the outlet chamber 30 and on towards the outlet 24. As noted above, when the separator 10 is used in a cleaning device some of the finer particles that do pass through the meshes 42, 44 are subsequently removed from the flow by a secondary separation stage such as a cyclone pack and trapped in a fine dust collector, for example via cone tips. The device may incorporate a further filter such as a HEPA filter downstream of the outlet 24 to provide a further level of purification.

FIG. 4 also shows that the primary flow entering the outlet chamber 30 through the primary mesh 42 flows directly into the outlet duct 35, and so reaches the outlet 24 relatively unimpeded. In contrast, the secondary flow entering the outlet chamber 30 through the secondary mesh 44 must navigate a series of features that create a more constricted flow path to the outlet 24. Specifically, the secondary mesh 44 extends over a portion of the duct wall 28 covering the space around the barrier 33, inside the outlet chamber 30. Air passing through the secondary mesh 44 must therefore flow around the barrier 33 to the radial passage 37 initially, and then through the radial passage 37 and a constricted opening into the outlet duct 35, to recombine with the primary flow and form an outlet flow that is discharged from the outlet 24.

The extent to which the primary and secondary flows are resisted, relative to each other, dictates the division of the initial inlet flow, as fluid favours the path of least resistance. If the primary flow is required to contain a greater portion of the inlet flow, the resistance to the secondary flow can be increased, for example by changing the geometry of the barrier 33. Conversely, reducing resistance to the secondary flow has the effect of increasing the portion of the inlet flow that joins the secondary flow and thereby increasing the volumetric flow rate of the secondary flow relative to the primary flow.

In this example, the resistance to the secondary flow is determined by the geometry of the barrier 33 and the radial passage 37. However, in other examples the secondary flow can be constrained in other ways, for example using tubes or orifices of suitable diameters and in suitable numbers.

In this example, the separator 10 is configured such that between 10-20% of the inlet air flow joins the secondary flow, so that the primary flow contains 80-90% of the inlet flow. This means that most of the air flowing through the separator 10 has a relatively simple flow path, due to the in-line topology of the separator 10 that places the inlet 22 and the outlet 24 close to mutual alignment. This, in turn, reduces the pressure consumption of the separator 10.

The ratio of the primary and secondary flows also partially determines the effectiveness with which dust is separated and retained in the inlet volume, including separation of particles that are of a size that can pass through the primary mesh 42.

Various benefits arise from the flow regime created within the separator 10.

For example, elegantly, configuring the inlet duct 32 and the primary mesh 42 so that the air flows across and substantially parallel to the mesh 42, and ensuring that part of this air flow—namely the secondary flow—travels the length of the primary mesh 42 before continuing into the bin volume 34, provides a continuous air flow across the primary mesh 42. This continuous flow acts as a protective curtain that resists debris from reaching the primary mesh 42, and clears the primary mesh 42 aerodynamically when the device is in operation, thereby reducing blinding of the primary mesh 42. In this respect, the flow across the mesh 42 generates high shear stress between the air flow and the particles, which creates an aerodynamic scrubbing effect that captures particles from the surface of the mesh 42.

Although the direction of the inlet air flow may not be precisely parallel to the primary mesh 42, for example being within 10° of a tangent of the mesh, advantageously the air flow is typically not directed at any part of the mesh 42 and so any larger particles entrained in the inlet air flow that could threaten to damage the mesh 42 are not carried into the mesh 42.

Another benefit of the separator 10 is that, because the primary mesh 42 is kept clear by the continuous washing, the diameter of the inlet 22 can be made larger. The velocity of the inlet flow is therefore lower than in existing designs, for a given flow rate. This reduced velocity in turn reduces jetting losses inside the separator 10, which is typically one of the dominant losses in a separator and so offers a significant improvement in the overall efficiency of the device. Similarly, the device can achieve the same efficiency as known arrangements whilst consuming less power.

Continuously washing the primary mesh 42 using the inlet air flow may allow the pore size of the mesh 42 to be reduced relative to known arrangements that use larger pore sizes to reduce blinding. Reducing the pore size in turn enhances the separation efficiency of the separator 10. Conversely, the shapes of the pores are more significant to separation performance in the separator 10 of this example, particularly the profiles of the leading edges of the pores with respect to the flow direction of the incoming air flow. In this respect, laser cut pores having straight edges and sharp corners may perform less effectively than electro-formed pores with more curved profiles facing the flow, for example.

In addition, the U-shaped configuration of the duct arrangement 26 protects the primary mesh 42 from debris moving in the bin volume 34, as the primary mesh 42 is nested within and thus shielded by the duct wall 28. This further reduces mesh blinding and lowers the risk of damage to the primary mesh 42.

Meanwhile, the use of dual meshes allows the separator 10 to be configured without a recirculating flow and the associated drawbacks. In addition to the problems noted above such as wrapping of hairs and fibres due to cyclonic flow, existing cyclonic separators are typically configured to turn and accelerate the inlet flow as it enters the separator, which creates a vulnerability to blockage of the inlet from larger debris. More generally, the in-line topology of the separator 10 of this example, and the removal of geometric constraints the apply for cyclonic separators, allows for a more compact configuration with less wasted space than for cyclonic separators.

The dual mesh arrangement and the U-shaped configuration of the duct arrangement 26 also allows the main flow to be isolated from the area in which dust accumulates, namely the bin volume 34, which minimises the impact of accumulated dust on the air flow. It follows that the pressure consumption of the separator 10 is not greatly impacted by filling of the bin volume 34.

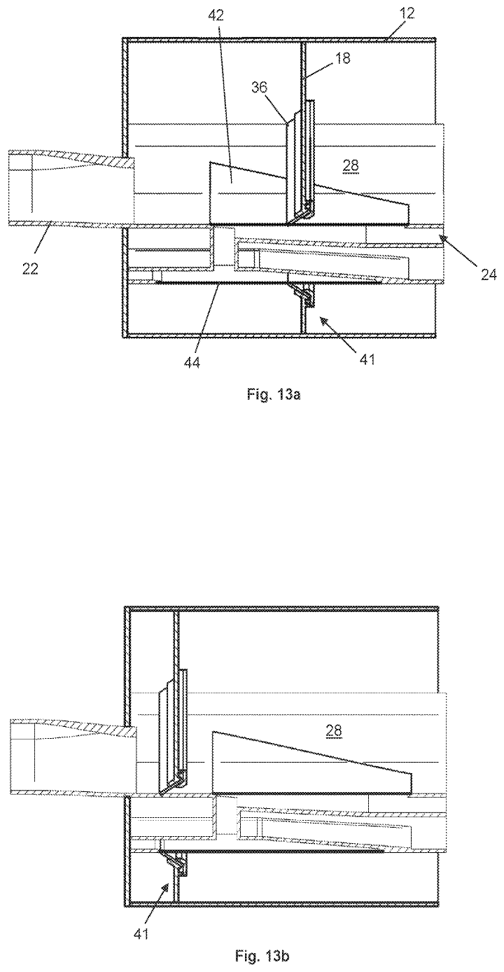

Turning finally to the operation of the wiper assembly 41, FIGS. 12a to 13b show a first arrangement, in which the duct arrangement 26 is fixed relative to the casing 12 and the wiper assembly 41 is configured to move axially relative to the duct arrangement 26. FIGS. 12a to 12c show the wiper assembly 41 in successive stages of a downward movement defining a cleaning stroke, and FIGS. 13a and 13b show corresponding stages of movement in longitudinal cross-section from the side. It is apparent from these figures that the wiper assembly 41 moves linearly, parallel to the central axis 14, while holding a constant orientation relative to the duct arrangement 26 and the casing 12. The wiper assembly 41 therefore moves in the manner of a plunger within the casing 12.

As the wiper assembly 41 undergoes the cleaning stroke, the wiper element 36 slides along the exterior of the duct wall 28, the resilience of the wiper element 36 pressing an outer edge of the element 36 into firm engagement with the surface of the duct wall 28. As the wiper element 36 passes over the primary and secondary meshes 42, 44, for example in the stages shown in FIGS. 12b and 13a, any debris that is lodged on the meshes 42, 44 is removed mechanically and carried towards the lower end wall 20 by the wiper element 36.

As the wiper element 41 is shaped to conform to the profile of the duct wall 28, contact between the wiper element 41 and the duct wall 28 establishes a continuous, gap-free cleaning interface around the duct wall 28 and the meshes 42, 44. As the cross-section of the duct wall 28 is uniform longitudinally, the cleaning interface is maintained throughout the cleaning stroke. This ensures that no gaps appear between the wiper element 36 and the duct 28, which could otherwise allow debris to become trapped between the wiper element 36 and the duct wall 28 and/or one of the meshes 42, 44.

Once the cleaning stroke completes, the debris removed from the meshes 42, 44 is deposited at the lower end of the housing, and the wiper assembly 41 can be retracted to its normal position at the top of the casing 12 in a return stroke.

Movement of the wiper assembly 41 through the cleaning and return strokes may be induced and controlled by an external actuating mechanism (not shown), which may be housed with the device above the separator 10, for example. It is also possible for the separator 10 to be configured for the wiper assembly 41 to be operated manually.

As noted above, the wiper element 36 and the outer periphery of the upper end wall 18 cooperate to seal the bin volume 34 and the inlet duct 32, thereby isolating the inlet volume from components of the actuating mechanism by containing debris in the inlet volume and so protecting the actuating mechanism from dust ingress to improve reliability.

A cleaning stroke may be performed when the separator 10 is detached from the device, in which case the lower end wall 20 may be opened or removed such that the separator 10 is open. This advantageously allows the dislodged debris to be emptied together with the accumulated debris held in the bin volume 34. Alternatively, the dislodged debris can be added to the debris already held in the bin volume 34, to be removed in a later emptying procedure.

It may also be possible to operate the wiper assembly 41 when the separator 10 is docked in the device, so that mesh wiping and bin emptying procedures can be performed independently. In this case, the dislodged debris will be added to the accumulated debris in the bin volume 34 for later emptying. For example, the meshes 42, 44 may be wiped automatically each time the device is activated. While it is possible for debris dislodged from the primary mesh 42 to fall into the inlet 22, this debris will be cleared and blown through to the bin volume 34 when the device is next operated. It is also possible for the inlet 22 to include a valve to resist debris falling into the inlet 22 from the inlet volume.

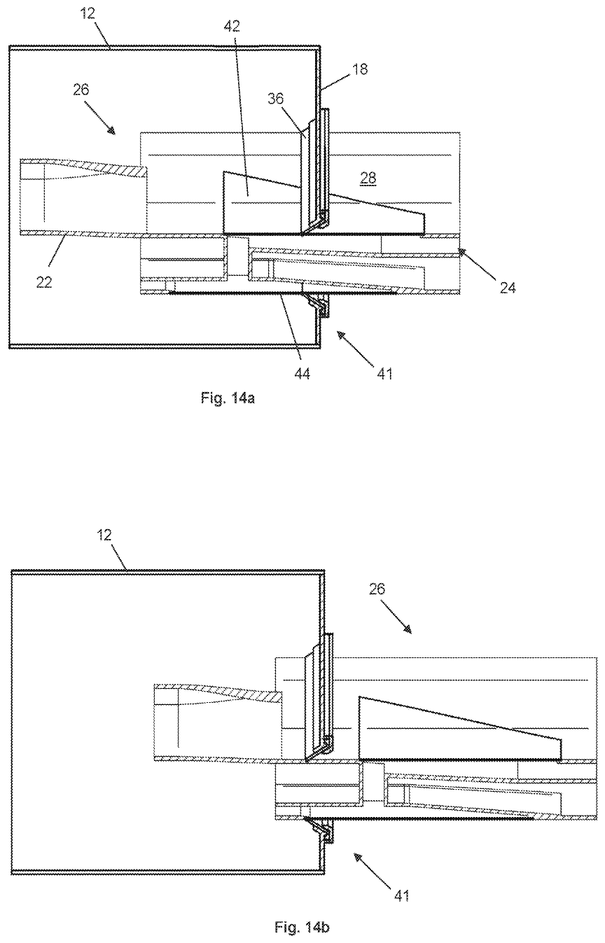

FIGS. 14a to 16b show similar stages of movement for an alternative configuration, in which the wiper assembly 41 is fixed relative to the casing 12, and the duct arrangement 26 instead moves relative to the casing 12 and the wiper assembly 41. This provides the relative movement required between the meshes 42, 44 and the wiper element 36. As for the first arrangement shown in FIGS. 12 and 13, debris attached to the primary and secondary meshes 42, 44 is dislodged as the wiper element 36 slides across the meshes 42, 44 and is retained in the inlet volume, to be emptied together with debris accumulated in the bin volume 34. The example shown in FIGS. 14a to 16b is otherwise identical to that of FIGS. 1 to 13.

In either of the approaches described above, relative movement between the wiper assembly 41 and the meshes 42, 44 takes place along an axis that is parallel to the central axis 14, creating a relatively simple configuration that performs reliably and robustly in the dusty environment inside the separator 10.

It will be appreciated that various changes and modifications can be made to the present invention without departing from the scope of the present application.

For example, the inlet duct could have various other shapes, including a box-like duct with a square or oblong cross-section and flat sides. The inlet duct may also not have a continuous open side as in the above example, but may instead have one or more discrete outlets allowing a secondary flow from the inlet duct into the bin volume.

Correspondingly, the duct wall may not be U-shaped or symmetrical as in the above example, but may take a variety of other forms. The duct wall may be oriented with any orientation with respect to the casing and/or housing. The casing and/or housing may be of any shape. In this respect, in embodiments the separating function of the separator is not heavily dependent on the shape of the housing and its walls for managing air flow, as in some known separators.

The duct wall may not be parallel with the primary mesh, the secondary mesh, or either. Similarly, the primary and secondary meshes may not be parallel to one another.

The continuous duct wall of the above embodiments may instead be formed from multiple parts. Similarly, the primary mesh and/or the secondary mesh may be formed from assemblies of separate parts.

Embodiments in which the duct arrangement is static and the wiper element moves during mesh wiping operations, and in which the wiper element is static and the duct arrangement moves, are described above. It is also possible to configure the separator such that both the duct arrangement and the wiper element move relative to the housing or another structure during wiping operations.

In some embodiments, the secondary mesh and the associated ducting may be omitted, so that the separator functions with a primary mesh alone.

There is also described herein a separator according to the following numbered clauses:
1. A separator for a cleaning device, the separator comprising:
   an inlet volume connected to an inlet of the separator for receiving a fluid flow containing entrained debris into the separator;
   a bin volume connected to the inlet volume, the bin volume being configured to collect debris separated from the fluid flow;
   an outlet volume connected to an outlet of the separator for discharging a filtered fluid flow from the separator;
   a first filter screen extending between the inlet volume and the outlet volume, the first filter screen being configured to retain debris in the inlet volume while allowing filtered fluid to flow from the inlet volume to the outlet volume; and
   a second filter screen extending between the bin volume and the outlet volume, the second filter screen being configured to retain debris in the bin volume while allowing filtered fluid to flow from the bin volume to the outlet volume.
2. The separator of clause 1, wherein the first filter screen and the second filter screen are mutually parallel.
3. The separator of clause 1 or clause 2, wherein the first filter screen and/or the second filter screen extends parallel to a longitudinal axis of the separator.
4. The separator of any preceding clause, comprising a wiping member configured to move across the first filter screen to remove debris attached to the first filter screen.
5. The separator of clause 4, wherein the wiping member is configured to move across the first and second filter screens simultaneously to remove debris attached to the first and second filter screens.
6. The separator of clause 4 or clause 5, wherein the wiping member is configured to move parallel to a longitudinal axis of the separator.
7. The separator of any of clauses 4 to 6, wherein the wiping member is supported by an end wall of the separator.
8. The separator of any of clauses 4 to 7, wherein the first and second filter screens are fixed relative to a housing of the separator, and the wiping member is configured to move relative to the housing.
9. The separator of any of clauses 4 to 7, wherein the wiping member is fixed relative to a housing of the separator, and the first and second filter screens are configured to move relative to the housing.
10. The separator of any of clauses 4 to 9, wherein the wiping member comprises a wiping edge that forms a closed loop, which wiping edge engages both the first filter screen and the second filter screen in operation.
11. The separator of any of clauses 4 to 10, wherein the wiping member is configured for actuation externally of the separator.
12. The separator of any preceding clause, wherein the inlet volume comprises at least one inlet duct connected to the inlet to receive the fluid flow, and wherein the first filter screen extends between the inlet duct and the outlet volume to retain debris in the inlet duct while allowing filtered fluid to flow from the inlet duct to the outlet volume.
13. The separator of clause 12, wherein the inlet duct extends parallel to the first filter screen.
14. The separator of clause 12 or clause 13, wherein the first filter screen forms part of a longitudinally-extending boundary wall interposed between the inlet duct and the outlet volume.
15. The separator of clause 14, wherein a wall of the inlet duct comprises the boundary wall.
16. The separator of any of clauses 12 to 15, wherein the inlet duct extends along a central longitudinal axis of the separator.
17. The separator of any of clauses 12 to 16, wherein the inlet duct comprises a side opening.
18. The separator of clause 17, wherein the inlet duct comprises an open-sided channel.
19. The separator of clause 17 or clause 18, wherein the side opening is on an opposite side of the inlet duct to the first filter screen.
20. The separator of any preceding clause, wherein the outlet volume comprises at least one outlet duct.
21. The separator of any preceding clause, comprising a primary flow path extending between the inlet and the outlet through the first filter screen, and a secondary flow path extending between the inlet and the outlet through the second filter screen, wherein the separator comprises at least one barrier formation located on the secondary flow path to constrain fluid flow along the secondary flow path relative to fluid flow along the primary flow path.
22. The separator of any preceding clause, wherein the first filter screen and/or the second filter screen curves around a longitudinal axis of the separator.
23. The separator of any preceding clause, wherein the second filter screen forms part of a longitudinally-extending boundary wall interposed between the bin volume and the outlet volume.
24. A cleaning device comprising the separator of any preceding clause.
25. The device of clause 24, embodied as a domestic appliance.
26. A method of configuring a separator for a cleaning device, the separator comprising an inlet volume connected to an inlet of the separator for receiving a fluid flow containing entrained debris into the separator, a bin volume connected to the inlet volume, the bin volume being configured to collect debris separated from the fluid flow, and an outlet volume connected to an outlet of the separator for discharging a filtered fluid flow from the separator, the method comprising:
   positioning a first filter screen between the inlet volume and the outlet volume, the first filter screen being configured to retain debris in the inlet volume while allowing filtered fluid to flow from the inlet volume to the outlet volume; and
   positioning a second filter screen between the bin volume and the outlet volume, the second filter screen being configured to retain debris in the bin volume while allowing filtered fluid to flow from the bin volume to the outlet volume.

1. A separator for a cleaning device, the separator comprising:
an inlet for receiving a fluid flow containing entrained debris into the separator;
an outlet for discharging a filtered fluid flow from the separator, the outlet being spaced longitudinally from the inlet;
an inlet duct extending within an interior volume of the separator, the inlet duct being connected to the inlet to receive the fluid flow;
an outlet volume connected to the outlet; and
a longitudinally-extending boundary wall interposed between the inlet duct and the outlet volume, the boundary wall comprising a filter screen that is configured to retain the debris in the inlet duct while allowing filtered fluid to flow from the inlet duct to the outlet volume.

2. The separator of claim 1, wherein the filter screen extends parallel to or curves around a longitudinal axis of the separator.

3. The separator of claim 1, wherein the inlet duct extends longitudinally from the inlet and/or extends along a central longitudinal axis of the separator.

4. (canceled)

5. The separator of claim 1, wherein the inlet duct comprises a side opening on an opposite side of the inlet duct to the filter screen.

6. (canceled)

7. (canceled)

8. The separator of claim 5, comprising a bin volume connected to the inlet duct via the side opening, the bin volume being configured to collect debris retained by the filter screen.

9. (canceled)

10. The separator of claim 8, wherein the bin volume at least partially surrounds the inlet duct and/or the outlet volume.

11. The separator of claim 1, wherein the outlet volume comprises at least one outlet duct.

12. The separator of claim 1, wherein the outlet volume at least partially surrounds the inlet duct.

13. The separator of claim 1, wherein the filter screen at least partially extends around the inlet duct in a plane transverse to a longitudinal axis of the separator.

14. The separator of claim 1, wherein the filter screen tapers longitudinally.

15. The separator of claim 1, wherein the inlet and the outlet are disposed at opposed longitudinal ends of the separator.

16. The separator of claim 1, wherein the inlet duct is terminated by an end wall of the separator.

17. (canceled)

18. The separator of claim 1, comprising a wiping member configured to move parallel to a longitudinal axis of the separator and across the filter screen to remove debris attached to the filter screen.

19. (canceled)

20. The separator of claim 1, wherein the boundary wall is defined by a wall of the inlet duct or by a wall of the outlet volume.

21. (canceled)

22. The separator of claim 1, wherein the boundary wall is defined by a wall of the outlet volume, and wherein the wall of the outlet volume comprises a recessed portion defining the inlet duct.

23. The separator of claim 1, wherein a transverse profile of the inlet duct and/or the outlet volume is uniform longitudinally.

24. (canceled)

25. The separator of claim 8, further comprising a second filter screen extending parallel to the filter screen, wherein the second filter screen is configured to retain debris in the bin volume while allowing filtered fluid to flow from the bin volume to the outlet volume.

26. The separator of claim 25, further comprising a primary flow path extending between the inlet and the outlet through the filter screen, and a secondary flow path extending between the inlet and the outlet through the second filter screen, wherein the separator comprises at least one barrier formation located on the secondary flow path to constrain fluid flow along the secondary flow path relative to fluid flow along the primary flow path.

27. (canceled)

28. A cleaning device comprising the separator of claim 1.

29. (canceled)

30. A method of configuring a separator for a cleaning device, the separator comprising an inlet for receiving a fluid flow containing entrained debris into the separator, an outlet for discharging a filtered fluid flow from the separator, the outlet being spaced longitudinally from the inlet, and an outlet volume connected to the outlet, the method comprising:
connecting an inlet duct extending within an interior volume of the separator to the inlet to receive the fluid flow; and
interposing a longitudinally-extending boundary wall between the inlet duct and the outlet volume, the boundary wall comprising a filter screen that is configured to retain the debris in the inlet duct while allowing filtered fluid to flow from the inlet duct to the outlet volume.
